(19) United States
(12) Patent Application Publication
(10) Pub. No.: US 2026/0029562 A1
(43) Pub. Date: Jan. 29, 2026

(54) LIGHT-CANCELLING ARTICLE AND PROJECTION APPARATUS

(71) Applicant: Holotronica Limited, Bristol (GB)

(72) Inventor: Stuart Warren-Hill, Bristol (GB)

(73) Assignee: Holotronica Limited, Bristol (GB)

(21) Appl. No.: 18/997,270

(22) PCT Filed: Jul. 19, 2023
(86) PCT No.: PCT/EP2023/070067

§ 371 Date: Jan. 21, 2025

(30) Foreign Application Priority Data
Jul. 22, 2022 (GB) 2210747.8

(51) Int. Cl. G02B 5/00; G02B 1/04; G02B 1/08; G02B 1/14; G02B 5/30; G03B 21/20; G03B 21/60

(52) U.S. Cl. CPC G02B 5/003; G02B 1/04; G02B 1/08; G02B 1/14; G02B 5/305; G03B 21/2073; G03B 21/60

(57) ABSTRACT

A light-cancelling article is described having a laminate structure comprising a light polarising filter and a substrate. Kits, light-cancelling systems, projection apparatus and light-cancelling apparatus including the article are also described. The article may be used during light projection methods to ameliorate the unwanted reflection of light spill and improve the viewing experience.

### FIELD OF THE INVENTION

The present invention relates to a light-cancelling article and a projection apparatus comprising the light-cancelling article for displaying images. Use of the projection apparatus for representing such images is also disclosed.

### BACKGROUND OF THE INVENTION

There is currently a demand for apparatus for projecting light as part of stage special effects or screenings. This is especially useful in concert performances and presentations, where impressive visual effects can enhance the viewing experience.

However, the viewing experience is deteriorated when there is unwanted light or video projection spill from surfaces surrounding the area of projection. The term “spill” or “light spill” refers to the unwanted reflection of light from surfaces during projection. For example, when projecting onto an optically-transparent or optically-translucent projection screen, some light will pass through the screen and may be reflected from surfaces surrounding the screen. These secondary reflections cause distractions for the audience which are detrimental to their experience.

Existing projection apparatuses use black applications such as black paint, black fabric or black flooring to absorb light and reduce projection spill. These applications at best are able to absorb between 20 and 70% of the light incident on the black surface. The remaining light is still reflected and can cause distractions for the audience which are detrimental to their experience.

The present invention was developed in an attempt to address this problem.

### SUMMARY OF THE INVENTION

The present invention provides a light-cancelling article and a projection apparatus. These provide the viewer with an enhanced viewing experience, cancelling unwanted light reflection from around the projection area to enhance the visual impact. The present invention provides an article which is easy to transport and install.

A first aspect of the invention is a light-cancelling article having a laminate structure comprising a light polarising filter and a substrate.

In this way, a light-cancelling article with a high degree of light absorption is provided. For example, the amount of light absorbed may be at least 90%.

A second aspect of the invention provides a kit comprising a plurality of light-cancelling articles of the first aspect.

A third aspect of the invention provides a light-cancelling system comprising a plurality of light-cancelling articles of the first aspect connected together.

In this way, an extended light-cancelling region is provided. The number of light-cancelling articles in the light-cancelling system is not particularly limited and may be adjusted to best suit the application.

A fourth aspect of the invention provides a projection apparatus comprising the light-cancelling article of the first aspect or the light-cancelling system according to the third aspect and a projector configured to project polarised light.

The light-cancelling articles are compatible with polarised projectors. Preferably light from the projector is polarised in an orientation which maximises the cancelling or attenuation of incident light on the article. For example, when linear polarisation of light and a linear polarising filter are used, light from the projector may be polarised in the perpendicular orientation to the polarising filter of the light-cancelling article. In this way, the light-cancelling article absorbs the maximum possible amount of light incident from the projector without retransmission. The light-cancelling articles can therefore be used to absorb any unwanted light reflection from a polarised projector to enhance the visual impact.

A fifth aspect of the invention provides the use of the projection apparatus of the fourth aspect to project polarised light onto a surface.

A sixth aspect of the invention is a light-cancelling apparatus comprising the light-cancelling article according to the first aspect or the light-cancelling system according to the third aspect, contained within a housing.

A seventh aspect of the invention is a method of manufacturing the light-cancelling article according to the first aspect.

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

### Substrate

The substrate may be an external or peripheral layer of the light-cancelling article. The substrate may provide structural support to the article. The substrate may make up an outer layer of the light-cancelling article which makes contact with an external surface when the light-cancelling article is positioned during use, for example upon a floor or a wall.

In some embodiments the substrate comprises or consists of one or more materials selected from wood, metal, and polymer. In some embodiments the substrate comprises or consists of a composite or engineered wood material. Examples of engineered wood include high-density fibre board (HDF) and medium-density fibre board (MDF). Examples of metal include aluminium. Examples of polymer include polymers well known to the skilled person such as polyethylene, polypropylene, and rubber (which may be natural or synthetic). Preferably the substrate comprises plywood with aluminium edges.

In some embodiments, the substrate is planar or substantially planar.

In some embodiments the substrate has a planar geometry, extending in two dimensions (length and width) which are greater than a third dimension of the substrate (thickness). In some embodiments, the length and width of the substrate are each at least 5 times the thickness of the substrate, for example at least 10 times, at least 15 times or at least 20 times. In some embodiments, the length and width of the substrate are each up to 50 times the thickness of the substrate, for example up to 40 times or up to 30 times.

In some embodiments the substrate comprises two planar surfaces, one on each side of the substrate, wherein a first planar surface faces the light-polarising filter (i.e. faces into the interior of the light-cancelling article). In some embodiments the light-absorbent layer contacts the first planar surface. In some embodiments a second planar surface of the substrate forms an external surface of the light-cancelling article. However, one or more additional layers may be present on the surface of the second planar surface of the substrate, the outermost layer of which will form an external surface of the light-cancelling article. For example, a high-friction external layer may be adhered to or attached to the second planar surface of the substrate to facilitate secure positioning of the light-cancelling article on a floor and minimise movement during use of the article. The first and second planar surfaces of the substrate are separated by the thickness of the substrate. The first and second planar surfaces of the substrate may be parallel or substantially parallel with one another.

The substrate may comprise a single integral layer of material, for example a single layer of wood, metal, or polymer.

In some embodiments, the thickness of the substrate is not particularly limited. Preferably the thickness of the substrate is in the range 5-25 mm. Even more preferably the thickness of the substrate is 15-20 mm, for example about 18 mm.

The substrate preferably has a length of at least 20 cm and a width of at least 20 cm. In some embodiments, the length and the width of the substrate are the same. The width of the substrate may be no more than 130 cm. Preferably both the length and the width of the substrate are about 122 cm.

In some embodiments the area of the substrate is at least 400 cm².

In some embodiments the area of the substrate is from 400 to 20,000 cm², for example from 1000 to 15,000 cm², from 5000 to 15,000 cm², from 10,000 to 15,000 cm², from 12,000 to 15,000 cm², or from 14,000 to 15,000 cm², for example about 14,884 cm².

In some embodiments the optical opacity of the substrate is at least 50%, for example at least 60%, at least 70%, at least 80% or at least 90%, where opacity is defined as:

$$Opacity ( \% ) = 100 \times [ 1 - ( {I}_{T} / {I}_{0} ) ]$$

where I_{T} is the amount of light transmitted by the substrate and I₀ is the amount of light incident on the substrate.

The substrate is preferably rigid. The Young's modulus of the substrate is preferably at least 5 MPa, more preferably at least 8 MPa.

In some embodiments, the substrate is configured for the light-cancelling article to be placed on the floor or on the wall. For example, the substrate may comprise a means of attaching the light-cancelling article to the wall. Preferably the attachment means is a grid frame which is attached to the wall and from which the tiles are supported.

In some embodiments, the substrate has a density of 500 to 8000 kg/m³. The density of the substrate is preferably 800 to 8000 kg/m³ when the light-cancelling article is placed on the floor and preferably 500 to 1500 kg/m³ when the light-cancelling article is placed on the wall.

In some embodiments, the substrate is textured on second planar surface to form a high-friction external layer the floor- or wall-engaging side of the substrate. This prevents unwanted movement of the light-cancelling article when in use.

The substrate is preferably non-polarised.

### Light Polarising Filter

The light-cancelling article comprises a light polarising filter. The light polarising filter absorbs incident light. Preferably the light polarising filter is a visual-light polarising filter. More preferably the incident light is polarised visual light that is polarised in an orientation which maximises the cancelling or attenuation of incident light on the article.

In some embodiments the light polarising filter is a linear polariser.

The skilled person is aware of suitable light-polarising filters which may be used as the light polarising filter in the article of the invention. Such filters are commercially available.

In some embodiments, the light polarising filter comprises a polyvinyl alcohol (PVA) film doped with iodine. Alternatively, the PVA film can be doped with a dye. The PVA chains are aligned in one particular direction such that light polarised parallel to the chains is absorbed and light polarised perpendicular to the chains is transmitted.

In some embodiments, the PVA film is interposed between two layers of tri-acetyl cellulose (TAC). TAC has good optical uniformity and transparency, and moderate mechanical strength. The TAC layers protect the physical properties of the PVA film, for example preventing hydrolysis of the PVA chains.

In some embodiments the light polarising filter comprises two planar surfaces, one on each side of the light polarising filter, wherein a first planar surface of the light polarising filter forms an external surface of the light-cancelling article. However, an additional protective film layer may be present on the surface of the first planar surface of the substrate, the protective film forming an external surface of the light-cancelling article. In some embodiments a second planar surface faces the substrate, or light-absorbent layer which is interposed between the substrate and the light polarising filter, (i.e. faces into the interior of the light-cancelling article).

In some embodiments, the light polarising filter is adhered to the substrate (or adhered to the light-absorbent layer which is interposed between the substrate and the light polarising filter). The light polarising filter may be adhered to the substrate with an adhesive layer.

The light polarising filter may be co-extensive with the substrate. In other words, the light polarising filter may extend to the edges of the substrate in two dimensions. In this way, the light-cancelling ability of the polarising filter is maximised since no area of the substrate will be accessible by incident light.

### Light-Absorbent Layer

In some embodiments the light-cancelling article further comprises a light-absorbent layer between the light polarising filter and the substrate. In this way, the absorbance of the incident light is increased, and the amount reflected is further reduced.

The light-absorbent layer is interposed between the light polarising filter and the substrate.

The light-absorbent layer may be co-extensive with both the light polarising filter and the substrate. In other words, the light-absorbent layer may extend to the edges of both the light polarising filter and the substrate in two dimensions. In this way, the light-cancelling ability of the light-absorbent layer is maximised since no area of the substrate will be accessible by incident light.

The light-absorbent layer is preferably black. This improves the black appearance of the light-cancelling article and improves absorbance of the article.

In some embodiments, the light-absorbent layer has an optical opacity of at least 50%, for example at least 60%, at least 70%, at least 80% or at least 90%, where optical opacity is the amount of visible light transmitted through the light-absorbent layer as a percentage of the total incident light on the light-absorbent layer.

In some embodiments, the light-absorbent layer has a total optical reflectance of less than 20%, for example less than 15%, less than 10%, less than 5%, less than 4% or less than 3%, where the total optical reflectance is the amount of both specular and diffuse reflected light as a percentage of the total incident light on the light-absorbent layer.

The light-absorbent layer is preferably optically opaque.

In some embodiments the light-absorbent layer has a thickness of at least 10 μm, for example at least 20 μm, at least 30 μm or at least 40 μm. In some embodiments the light-absorbent layer has a thickness of up to 100 μm, for example up to 90 μm, up to 80 μm or up to 60 μm.

In some embodiments the light-absorbent layer is a black coating. The black coating is preferably a laminated polypropylene black coating.

In some embodiments the light-absorbent layer is black paint. The black paint can be brush paint or spray paint.

In some embodiments the light-absorbent layer is adhered to the substrate. The light-absorbent layer may be paint which is adhered to the substrate by coating the paint onto the surface of the substrate and allowing the paint to dry. Alternatively, the light-absorbent layer may be black coloured polypropylene laminated onto the surface of the substrate.

The light-absorbent layer may be adhered to the light polarising filter.

The light-absorbent layer may be adhered to both the substrate and the light polarising filter.

### Protective Film

In some embodiments, the light-cancelling article further comprises a removable protective film on the surface of the light polarising filter.

In some embodiments, the protective film comprises polyethylene terephthalate (PET). Alternatively, the protective film comprises polyethylene (PE). In some embodiments, the protective film comprises both PET and PE.

The protective film may be co-extensive with the surface of the light polarising filter. In other words, the protective film may extend to the edges of the light polarising filter in two dimensions. In this way, the entire surface of the light polarising filter is protected.

The protective film may be removeable. It is preferable that the protective film is removed before use of the light-cancelling article.

The protective film may be adhered to the surface of the light polarising filter with an adhesive layer. Suitable adhesive layers are known to the skilled person.

In some embodiments, the laminate structure comprising the light polarising filter and the protective film is a commercially available laminate, for example laminate polarised film with PVA interposed between two layers of TAC (“linear polarised filter”; HS Code 9004909000), available from Shenzhen Lionstar Technology Co., Ltd, Guangdong, China. In some embodiments, the commercially available article comprises protective films on either side of the light polarising filter, and one film is removed before assembling with the light absorbent layer and the substrate to form the light-cancelling article.

### Light-Cancelling Article

In some embodiments, the light-cancelling article comprises connecting means to engage the light-cancelling article with one or more further light-cancelling articles.

In some embodiments, the connecting means facilitate reversible engagement of the light-cancelling article with one or more further light-cancelling articles. The connecting means may provide interlocking surfaces on the light-cancelling article and the one or more further light-cancelling articles.

In some embodiments, the light-cancelling article comprises one or more connecting elements to engage with one or more connecting elements of one or more further light-cancelling articles. In some embodiments the connecting element is located at the periphery of the light-cancelling article. In this way several light-cancelling articles may be placed side-by-side and connected together by the connecting elements to produce a light-cancelling system comprising a plurality of light-cancelling articles connected together.

The connecting element may comprise a cam lock device, bolts, magnets, a tongue and groove device or tessellated interconnected edges. Preferably the connecting element is a cam lock device.

In some embodiments the light-cancelling article has a shape which facilitates tessellation. Non-limiting examples of shapes which will allow the articles to be tessellated include triangular, square, rectangular, and hexagonal.

In some embodiments the light-cancelling article has a thickness of 5-25 mm, for example from 10-20 mm or from 15-20 mm, or about 18 mm.

In some embodiments the light-cancelling article has a length of at least 20 cm. In some embodiments the light-cancelling article has a width of at least 20 cm. In some embodiments, the length and the width of the light-cancelling article are the same.

The length of the light-cancelling article may be no more than 130 cm. The width of the light-cancelling article may be no more than 130 cm. Preferably both the length and the width of the light-cancelling article are about 122 cm.

### Floor/Wall Tiles

In some embodiments, the light-cancelling article is a floor tile or a wall tile.

In some embodiments, the substrate comprises a means of attaching the light-cancelling article on the wall.

In some embodiments, the light-cancelling articles are supported by a grid frame which is attached to the wall.

In some embodiments, the light-cancelling articles are suspended from a truss.

### Kit

A second aspect of the invention provides a kit comprising a plurality of light-cancelling articles of the first aspect.

Each of the plurality of light-cancelling articles in the kit may comprise connecting means to engage the light-cancelling article with one or more further light-cancelling articles, as discussed in detail above.

The light-cancelling articles within the kit may each be identical. The light-cancelling articles within the kit may be capable of assembly into a light-cancelling system comprising the plurality of light-cancelling articles connected together.

### Light-Cancelling System

A third aspect of the invention provides a light-cancelling system comprising a plurality of light-cancelling articles of the first aspect connected together.

In some embodiments the system is a modular system, comprising a plurality of separate modules, each module comprising a light-cancelling article of the first aspect.

In this way, an extended light-cancelling region is provided. The number of light-cancelling articles in the light-cancelling system is not particularly limited and may be adjusted to best suit the application. In some embodiments, the light-cancelling system comprises at least 5, for example at least 10, at least 20, at least 50 or at least 100 individual light-cancelling articles, each light-cancelling article being connected to at least one other light-cancelling articles in the system.

The light-cancelling articles within the system may be reversibly connected to one another.

Each of the plurality of light-cancelling articles in the system may comprise connecting means to engage each light-cancelling article within the system with one or more further light-cancelling articles, as discussed in detail above.

In some embodiments, the connecting means facilitate reversible engagement of a light-cancelling article with one or more further light-cancelling articles within the system. The connecting means may provide interlocking surfaces on the light-cancelling article and the one or more further light-cancelling articles.

In some embodiments, each light-cancelling article within the system comprises one or more connecting elements to engage with one or more connecting elements of one or more further light-cancelling articles within the system. In some embodiments the connecting element is located at the periphery of each light-cancelling article. In this way several light-cancelling articles may be placed side-by-side and connected together by the connecting elements to produce the light-cancelling system wherein a plurality of light-cancelling articles connected together.

The connecting element may comprise a cam lock device, bolts, magnets, a tongue and groove device or tessellated interconnected edges. Preferably the connecting element is a cam lock device.

In some embodiments the light-cancelling articles within the system are tessellated. In other words, the plurality of light-cancelling articles in the system may be connectable together in such a way as to provide no gaps between any two directly connected light-cancelling articles and require no lateral overlap between any two connected light-cancelling articles. In this way the light-cancelling effect of the system is maximised, with no possible light spill arising from reflections from a surface beneath the articles due to gaps between the articles.

The skilled person will be aware of possible shapes of article which will facilitate tessellation. Non-limiting shapes which will allow the articles in the system to be tessellated include triangular, square, rectangular, and hexagonal. In some embodiments each article within the system has the same shape and size. In some embodiments each article within the system is of identical shape and construction. However it will be appreciated that this is not necessary to achieve tessellation and the system may comprise articles having two or more different shapes and/or sizes.

Other structures of light-cancelling system are encompassed by the invention. For example, instead of individual articles which are reversibly connected together, the system may be foldable or collapsible to reduce the overall laterally extensive size of the article to permit transport. In such cases the system may comprise a plurality of light-cancelling articles which are reversibly connected together as described above, or alternatively irreversibly or permanently attached or connected together while allowing the aforementioned folding of the system.

The invention also provides a method of assembling a plurality of light-cancelling articles of the first aspect into a light-cancelling system of the third aspect. The method may comprise connecting the plurality of light-cancelling articles such that they are tessellated into an extended light-cancelling region.

### Projection Apparatus

The projection apparatus of the fourth aspect comprises the light-cancelling article according to the first aspect or the light-cancelling system according to the third aspect, and a projector configured to project polarised light.

The polarisation of the light from the projector is preferably of the same type which arises from the interaction of light with the light polarising filter of the light-cancelling article. For example, when the light from the projector is linear polarised, the light polarising filter of the light-cancelling article is preferably a linear polarising filter. When the light from the projector is circular polarised, the light polarising filter of the light-cancelling article is preferably a circular polarising filter.

The orientation of the polarised light from the projector and the light polarising filter of the light-cancelling article are preferably optimised to provide the maximum attenuation of incident light and reduce reflected light from the light-cancelling article. For example, the polarised light from the projector and/or the light polarising filter of the light-cancelling article may be oriented such that the relative orientation is perpendicular, when the polarisation is linear. The polarised light from the projector and/or the light polarising filter of the light-cancelling article may be oriented in opposite directions (e.g. one clockwise, one anticlockwise), when the polarisation is circular.

Any means known to the skilled person for the projection of polarised light may be used by the projector. The polarisation of the light may be achieved by one or more of transmission through a suitable polarising filter, reflection from a suitable polarising surface, refraction, and scattering, provided that the light becomes polarised before striking the surface of the light-cancelling article. The polarisation may take place within the projector itself, or at a position between the projector and the light cancelling article. For example, a polarising filter may be placed in the path of the light at some point between the projector and the light-cancelling article.

In some embodiments, the polarisation of the light from the projector is achieved by a polarising filter, for example a linear polarising filter.

In some embodiments, the projector comprises a polarising filter. The polarising filter is preferably a linear polariser. More preferably the polarising filter is a linear polariser oriented in the opposite direction to the polarising filter of the light-cancelling article. Preferably the projector is a single Digital Light Processing (DLP) or Liquid Crystal Display (LCD) video projector.

The projection apparatus may be used in a variety of light projection applications. For example, the apparatus may be used to illuminate a person or object. In such cases the projector will be positioned to project the polarised light onto the person or object, and the light-cancelling article or system will be positioned around and/or behind the person or object in such a way to ensure that any light from the projector which does not fall upon the person or object falls upon the light cancelling article or system. In this way, light spill from the area surrounding the person or object is ameliorated, helping the audience to focus on the person or object and reducing distractions.

Alternatively, the apparatus may be used to illuminate a screen, for example a woven fabric (e.g. tulle) screen. In such cases the projector will be positioned to project the polarised light onto the screen, either from the “front” side (i.e. the same side as the audience) or from the “rear” side (i.e. the opposite side of the audience), and the light-cancelling article or system will be positioned such that any light which passes through the screen falls upon the light cancelling article or system. In this way the vast majority of reflected light originates from the screen, enhancing the visual effect, and light spill from surrounding surfaces is ameliorated.

Thus in some embodiments the projection apparatus further comprises a projection display screen.

The projection display screen is preferably a woven textile projection display screen comprising a projection display region on a projection display side of the display screen.

The projection display region is the area on the projection display screen upon which images will be projected, or the area suitable for displaying projected images. The projection display side is the side of the screen onto which images are projected, or which is suitable for displaying projected images.

The projection display region preferably has two or more interwoven yarns and each yarn in the projection display region includes a metal coating or plating. The metal coating or plating is preferably silver metal.

In some embodiments, the projection display screen is a screen as described in GB 2512824 A, the entire contents of which are incorporated herein by reference. For example, in some embodiments the projection display screen is a screen as described from page 3 line 2 to page 7 line 7 of GB 2512824 A.

The projection apparatus allows the representation of images when light is projected from the projecting means onto the projection screen. These images may be 2D or 3D images. If 3D images are to be represented, two projectors, each comprising a polarising filter, or a single projector with a switchable polarising filter is required and the viewer is required to wear passive polarised filter glasses. The images may be stationary or moving. Preferably the images are moving images. Preferably the projection apparatus is a polarised 2D projection apparatus.

### Projection Method

A fifth aspect of the invention provides the use of the projection apparatus of the fourth aspect to project polarised light onto a surface. In some embodiments the surface is a surface of a person or an object to be illuminated. In some embodiments the surface is a surface of a projection display screen as described under the fourth aspect. In some embodiments the invention provides the use of the projection apparatus according to the fourth aspect to represent an image. In some embodiments, the image is selected from a moving image and a still image. In some embodiments, the image is selected from a 2D image and a 3D image.

The invention also provides the use of the light-cancelling article according to the first aspect to prevent or ameliorate unwanted light spill during light projection. The invention also provides the use of the light-cancelling article according to the first aspect in a wall tile or floor tile to prevent or ameliorate unwanted light spill during light projection. The invention also provides the use of the light-cancelling article according to the first aspect to prevent or ameliorate unwanted light spill during the projection of polarised light onto a projection display screen. The invention also provides the use of the light-cancelling article according to the first aspect in a wall tile or floor tile to prevent or ameliorate unwanted light spill during the projection of polarised light onto a projection display screen.

The invention also provides a method of projecting light using the projection apparatus of the fourth aspect. In some embodiments the method comprises projecting light onto a person, an object, or a projection display screen, wherein at least some of the projected light strikes the light-cancelling article.

The invention also provides a method of preventing or ameliorating unwanted light spill using the light-cancelling article of the first aspect. The invention also provides a method of preventing or ameliorating unwanted light spill during a light projection process, using the light-cancelling article of the first aspect. The invention also provides a method of preventing or ameliorating unwanted light spill during the projection of light onto a projection display screen, using the light-cancelling article of the first aspect.

The invention also provides a method of preventing or ameliorating unwanted light spill during a light projection process, using the projection apparatus of the fourth aspect.

### Light-Cancelling Apparatus

A sixth aspect of the invention is a light-cancelling apparatus comprising the light-cancelling article according to the first aspect or the light-cancelling system according to the third aspect, contained within a housing.

The housing may be of a size which allows a person to be contained within the housing during use. In some embodiments the housing is a box or booth, for example a box or booth open on one side but otherwise closed.

The housing may comprise an opening. In some embodiments, the opening is sized to allow a person to enter and exit the housing.

In some embodiments the housing is an elongate, upright box or booth, comprising an upwardly extending opening on one side which allows a person or object to enter and exit the housing.

In some embodiments, the housing comprises a floor and at least one wall extending away from the floor, wherein the floor and the wall comprise respective first and second inner surfaces of the housing. In some embodiments, the first inner surface supports the light-cancelling article according to the first aspect or the light-cancelling system according to the third aspect. In some embodiments, the second inner surface supports the light-cancelling article according to the first aspect or the light-cancelling system according to the third aspect.

In some embodiments, both the first and second inner surfaces independently support the light-cancelling article according to the first aspect or the light-cancelling system according to the third aspect.

In this way, a housing is provided which includes one or more inner surfaces comprising the light-cancelling article (or system), thereby absorbing any light spill from projection into the housing which falls upon these inner surfaces.

In some embodiments, the first inner surface is located on the floor of the housing and the second inner surface is located on an internal rear wall of the housing, wherein the internal rear wall is positioned opposite the opening in the housing. In this way, unwanted light spill from light which is projected into the opening falls primarily upon one or more of the first and second inner surfaces.

In some embodiments, the housing comprises a cuboidal frame. In some embodiments, the cuboidal frame comprises 12 rods or rails, forming the 12 edges of the cuboid and defining three pairs of faces. The cuboidal frame may define a first pair of faces, a second pair of faces, and a third pair of faces, wherein two faces in a pair are parallel to one another and face one another, and wherein the first, second and third pairs of faces are mutually perpendicular. In some embodiments, the faces in the first pair of faces have an area smaller than the faces in either the second or third pair. In some embodiments, the faces in the first pair of faces are squares. In some embodiments, the faces in the second pair of faces are rectangles. In some embodiments, the faces in the third pair of faces are rectangles.

In some embodiments, the area of the faces in the second pair of faces is equal to the area of the faces in the third pair of faces.

In some embodiments, the faces in the first pair of faces comprise the floor and ceiling of the housing during use. In other words, during use the housing may sit on one of its smaller faces, thereby providing an elongate housing in the upwards direction. In this way, the housing may be adapted to hold a person standing upright during use.

In some embodiments, during use, the faces in the first pair of faces comprise the floor and ceiling of the housing, the faces in the second pair of faces comprise the front and back of the housing and the faces in the third pair of faces comprise the sides of the housing.

In some embodiments, the face of the housing (within the first pair of faces) which comprises the floor of the housing is closed, providing a solid floor of the housing, wherein the floor comprises a light-cancelling article according to the first aspect or a light-cancelling system according to the third aspect positioned on an inner surface of the housing.

In some embodiments, the face of the housing (within the first pair of faces) which comprises the ceiling of the housing is closed, providing a solid ceiling of the housing, wherein the ceiling comprises a solid panel.

The solid panel may comprise a wooden panel, for example MDF or plywood. The solid panel may comprise a light-cancelling article according to the first aspect or a light-cancelling system according to the third aspect.

In some embodiments, the face of the housing (within the second pair of faces) which comprises the back of the housing is closed, providing a back upright wall of the housing, wherein the back upright wall comprises a light-cancelling article according to the first aspect or a light-cancelling system according to the third aspect, positioned on an inner surface of the housing.

In some embodiments, the face of the housing (within the second pair of faces) which comprises the front of the housing is open, providing an opening in the front of the housing. In this way, either a person may enter the opening, or light may be projected into the opening.

In some embodiments, each of the two faces within the third pair of faces, which comprise the sides of the housing, are closed, providing side walls of the housing. The side walls may comprise fabric. The side walls may comprise a dark fabric sheet extending across the entire face of the housing. Such fabric walls are lightweight and easy to install, for example using reversible fasteners such as hook-and-loop fasteners. Ensuring that the fabric is dark helps to reduce any reflections from light spill onto the side walls.

Light spill onto the internal side walls of the housing can be mitigated by ensuring that the projected light is not directed onto the side walls, and that any light spill would fall onto the floor or rear wall where the light-cancelling article or system is located. As such, it is not necessary that the internal side walls also comprise the light-cancelling article, and a dark substrate such as dark fabric is sufficient. This keeps the entire housing lightweight and easy to transport, assemble and disassemble.

In some embodiments, the light-cancelling apparatus comprises a projection display screen. In some embodiments, the projection display screen is attached to the housing. In some embodiments, the projection display screen is located within the housing.

In some embodiments, light-cancelling apparatus further comprises a projector configured to project polarised light into the housing. In some embodiments, light-cancelling apparatus further comprises a projector configured to project polarised light onto the projection display screen. The projector may be configured to project polarised light into the opening of the housing. The projector may be located either within the housing itself or outside the housing, but in either case the projector is configured to project the light into the housing. The projector may be configured to project polarised light into the opening of the housing and onto the projection display screen.

Any image or video may be projected onto the projection display screen. In such cases the projector will be positioned to project the polarised light onto the screen, either from the “front” side (i.e. the same side as the audience) or from the “rear” side (i.e. the opposite side of the audience), and the light-cancelling article or system will be positioned within the housing such that any light which passes through the screen falls upon the light cancelling article or system. In this way the vast majority of reflected light originates from the screen, enhancing the visual effect, and light spill from surrounding surfaces is ameliorated.

In some embodiments, the projection display screen at least partially covers the opening. In this way, when an image or video is projected onto the projection display screen, it gives the impression that the person or object in the image or video is located within the opening of the housing.

The projection display screen in the housing may be removable. When the projection display screen is present, an image or video may be projected onto the projection display screen by the projector and any light which passes through the screen and falls upon the light-cancelling article or system will be absorbed, giving the illusion that the person or object is located within the housing. In this way, the housing may be used to provide an enhanced viewer experience.

Alternatively, when the projection display screen is absent (i.e. has been removed from the housing or has not been installed in the housing), it is possible for a person or object to enter the housing through the front opening and be located in the interior of the housing, enclosed by the second and third pairs of faces of the housing frame. In such embodiments, the light-cancelling apparatus may further comprise an image or video recording device. Such a device may be provided either within the housing itself, or outside but in the vicinity of the housing. An image or video footage of the person or object inside the housing may then be collected by the image or video recording device. This image or video footage may then be projected into a second housing, containing a projection display screen, either in real-time as the image or video is collected, or at a later point in time.

In this way, a person or object may be located within a first housing, with an image or video of the person or object collected from the first housing, and the same image or video may then be projected onto a projection display screen located within a second housing at a different location to the first housing. The person or object then appears to be in the second housing, and this illusion is enhanced by the presence of the light-cancelling article or system within the second housing which prevents unwanted light spill from the inner surface(s) of the housing.

Thus in some embodiments the light-cancelling apparatus comprises:
a first housing comprising a light-cancelling article according to the first aspect or a light-cancelling system according to the third aspect;
an image or video recording device configured to record an image or video of a person or object located within the first housing;
a second housing comprising a light-cancelling article according to the first aspect or a light-cancelling system according to the third aspect, and a projection display screen; and
a projector configured to project polarised light into the second housing, wherein the projector is configured to project the image or video recorded by the image or video recording device.

This may be useful, for example, for entertainment purposes where a person or object is placed into the first housing and appears to “teleport” into the second housing. Alternatively, it may be useful for communication purposes, for example when a person intends to deliver a public speech from a distant location and can appear to be present within the second housing at a desired location to deliver the speech, when in fact they are in a different location in the first housing.

The projection display screen may be removably attached to a rail within the housing. The projection display screen may be removably attached to the housing around its entire periphery, thereby ensuring that the surface of the projection display screen remains taut and therefore smooth, which will result in a better-quality projection.

In some embodiments, the projection display screen comprises attachment elements around its peripheral edge which are adapted to connect with and be held by attachment elements in the housing. In some embodiments, the projection display screen is rectangular and sized to fit the rectangular front opening of the housing such that the projection display screen covers substantially the entire front opening. In some embodiments, the attachment elements of the projection display screen comprise a rail running along the edge of the projection display screen which fits into a slot running along an edge of the housing. An example of such cooperating rails and slots are Keder tube and Keder rail.

The plane of the projection display screen may be flush with the front face of the housing, or the projection display screen may be inset within the housing. In some embodiments the plane of the projection display screen is parallel with the second pair of faces of the housing (i.e. the front and rear faces).

The housing may be of a size which facilitates locating a person within the housing. In some embodiments, the housing has a length (height) of at least 100 cm, for example at least 120 cm, at least 130 cm, at least 140 cm, at least 150 cm, at least 160 cm, at least 170 cm, at least 180 cm, at least 190 cm or at least 200 cm. In some embodiments, the housing has a length (height) of up to 250 cm, for example up to 240 cm, up to 230 cm, up to 220 cm, up to 210 cm or up to 200 cm. In some embodiments, the housing has a length (height) of from 100 to 250 cm, for example from 150 to 250 cm, for example from 180 to 220 cm, or about 200 cm.

In some embodiments, the housing has a depth of at least 50 cm, for example at least 60 cm, at least 70 cm, at least 80 cm, at least 90 cm or at least 100 cm. In some embodiments, the housing has a depth of up to 150 cm, for example up to 140 cm, up to 130 cm, up to 120 cm, up to 110 cm or up to 100 cm. In some embodiments, the housing has a depth of from 50 to 150 cm, for example from 60 to 140 cm, for example from 80 to 120 cm, or about 100 cm.

In some embodiments, the housing has a width of at least 50 cm, for example at least 60 cm, at least 70 cm, at least 80 cm, at least 90 cm or at least 100 cm. In some embodiments, the housing has a width of up to 150 cm, for example up to 140 cm, up to 130 cm, up to 120 cm, up to 110 cm or up to 100 cm. In some embodiments, the housing has a width of from 50 to 150 cm, for example from 60 to 140 cm, for example from 80 to 120 cm, or about 100 cm.

It will be understood that the depth is the distance from the opening to the rear wall of the housing, and the width is the distance between the two side walls.

Further details of the projection display screen and projector configured to project polarised light are provided above in the description of the projection apparatus, and for brevity are not repeated here.

### Manufacturing Method

A seventh aspect of the invention is a method of manufacturing the light-cancelling article according to the first aspect.

In some embodiments, the method comprises forming a laminate structure by assembling together a substrate and a light polarising filter.

In some embodiments, the method comprises forming a laminate structure by assembling together a substrate, a light polarising filter and a light-absorbent layer between the substrate and the light polarising filter.

In some embodiments, the method comprises providing a substrate, applying a light-absorbent layer to a surface of the substrate, and applying a light polarising filter to a surface of the light absorbent layer. In some embodiments, applying the light polarising filter comprises removing a protective film from a laminate light polarising filter to reveal a layer of adhesive, and adhering the light polarising filter to the light absorbent layer via the layer of adhesive.

All the options and preferences for the light-cancelling article set out above in respect of the first aspect apply equally to the method of the seventh aspect, such as the options for the substrate, light polarising filter and light-absorbent layer.

### BRIEF DESCRIPTION OF THE DRAWINGS

FIG. 1 is a profile view of an embodiment of the light-cancelling article showing the laminate structure.

FIG. 2 is an overhead view of an embodiment of the projection apparatus assembled in one suitable arrangement for projection.

FIG. 3 is a perspective view of an embodiment of the projection apparatus assembled in one suitable arrangement for projection.

FIG. 4 is a perspective view of an embodiment of the light-cancelling apparatus comprising the light-cancelling article or light-cancelling system, within a cuboidal housing.

FIG. 5 is a perspective view of an embodiment of the light-cancelling apparatus comprising the light-cancelling article or light-cancelling system, within a cuboidal housing which also contains a projection display screen.

### DETAILED DESCRIPTION

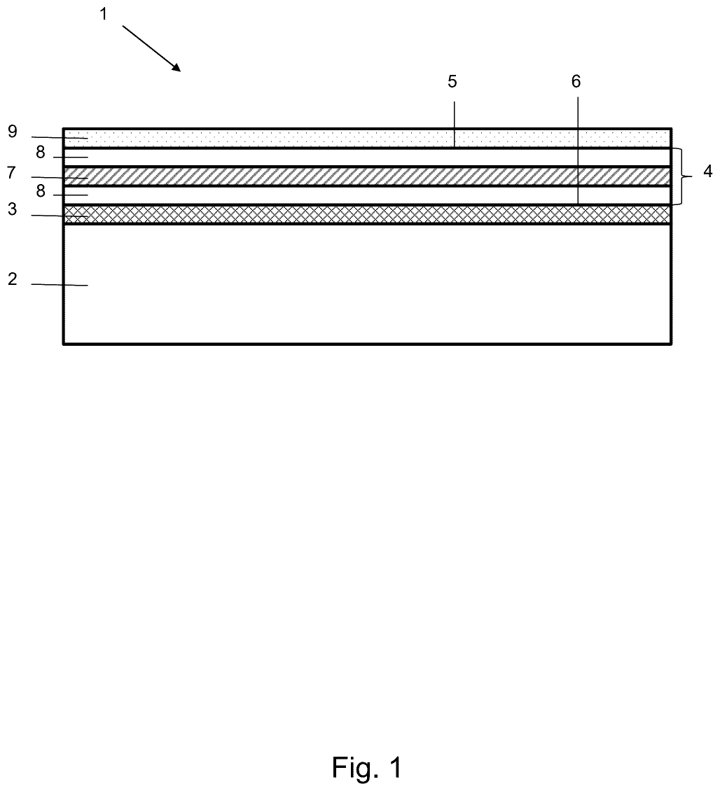

FIG. 1 shows one embodiment of the light-cancelling article 1 of the invention. The article has a laminate structure comprising a substrate 2, a light absorbent layer 3, a polarising filter 4 and a protective film 9, in sequence. In this particular embodiment the substrate consists of wood and the light absorbent layer is polypropylene laminate. The light absorbent layer is adhered to the substrate by laminating the surface of the substrate. The polarising filter 4 is located on top of the light absorbent layer and comprises two planar surfaces, 5 and 6. The polarising filter is a linear polarising filter consisting of a PVA layer 7 inbetween two TAC layers 8. The second planar surface 6 of the light polarising filter is adhered to the light absorbent layer with suitable adhesive. The protective film 9 forms the uppermost layer of the laminate structure and is on the first planar surface 5 of the light polarising filter. In this particular embodiment the protective film is polyethylene terephthalate (PET). The total thickness of the light-cancelling article is 18 mm.

When the light-cancelling article is in use, the protective film 9 is removed. Light is incident on the first planar surface 5 of the light polarising filter and absorbed. In this particular embodiment, the incident light is linearly polarised visible light. The light polarising filter of the light-cancelling article is also linearly polarised and oriented perpendicular to the orientation of the polarised incident light. As such, the light-polarising filter absorbs the maximum possible amount of incident light without reflection, thereby preventing or ameliorating unwanted light spill during the light projection process.

Various modifications will be apparent to those skilled in the art. For example, other substrates may be used for the purpose of the invention; a different light polarising filter or light absorbent layer may also be used.

In an alternative embodiment, substrate 2 is made from neoprene and light absorbing layer 3 is a layer of black paint.

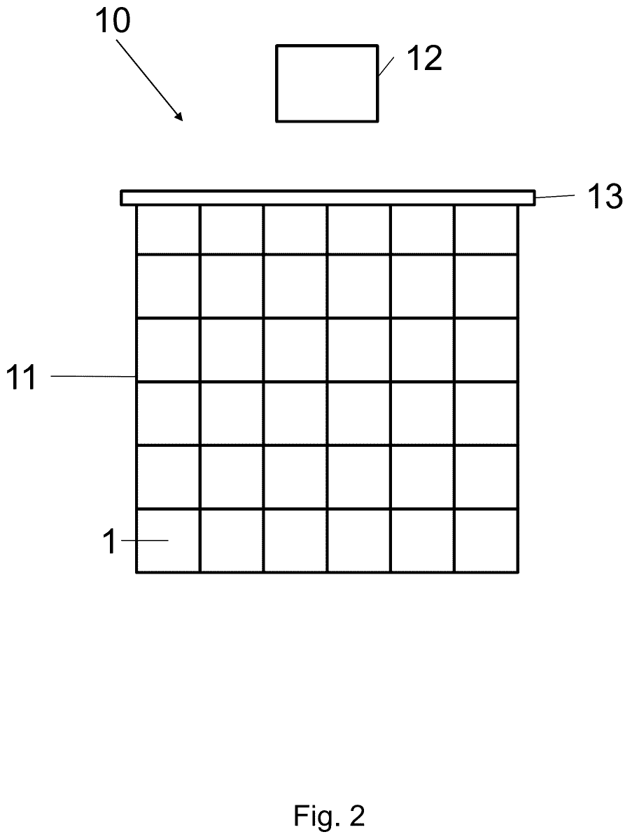

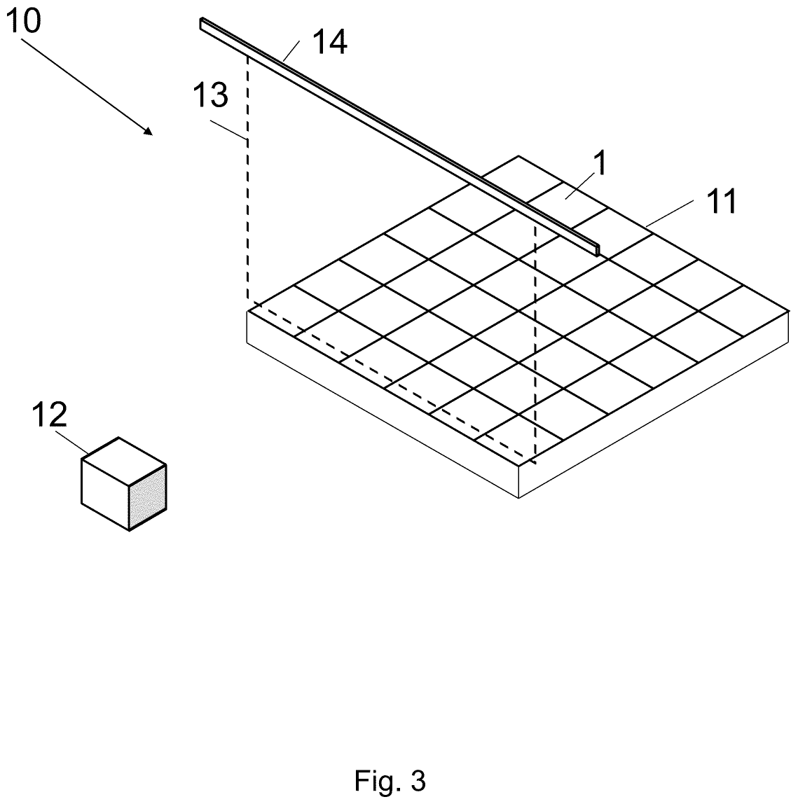

FIGS. 2 and 3 show an embodiment of a projection apparatus 10. The projection apparatus includes a light-cancelling system 11 comprising a plurality of light-cancelling articles 1 connected together, a projector 12 and a projection display screen 13.

The projection display screen 13 is suspended from support bar 14 along the upper edge of the screen. The projection display screen is a metallic silver bobbinet scrim. Extending behind the projection display screen and perpendicular thereto is the light-cancelling system 11 comprising a plurality of light-cancelling articles 1 connected together. In this particular embodiment, the connecting element is a cam lock device, but bolts or magnets could easily be used instead, and the light-cancelling articles are floor tiles. The light-cancelling articles have dimensions of 1.22 m×1.22 m and a thickness of 18 mm. When the apparatus is in use, the projection display screen is illuminated by the projector. The projector can be a Digital Light Processing (DLP) or Liquid Crystal Display (LCD) type projector. The projector includes a polarising filter at the front of the lens through which the projected light passes. In this embodiment the filter is a linear polarising filter, oriented in the perpendicular direction to the polarising filter of the light-cancelling articles. In this way the light-cancelling system absorbs the maximum possible amount of incident light that strikes it after passing through the projection display screen, reducing the amount of light reflected, thereby preventing or ameliorating unwanted light spill during the light projection process. This provides an enhanced visual effect.

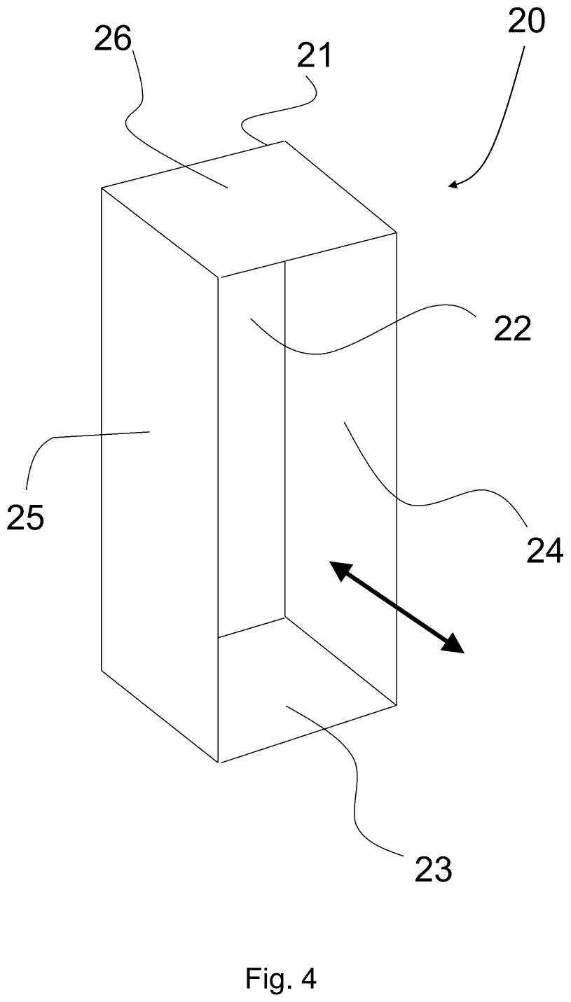

FIG. 4 shows light-cancelling apparatus 20 which includes a housing 21. The housing 21 takes the form of an upright box or booth having an opening at the front into which a person is able to enter and exit, as indicated by the double-headed arrow. The housing includes a cuboidal frame made up of metal rods which form the edges of the housing 21. The floor 23 of the housing includes a light-cancelling article as described above on its surface. The rear wall 22 also includes one or more light cancelling articles on its inner surface. As a result, the bottom inner surface and rear inner surface of the housing have light-cancelling properties.

The side walls 24 and 25 of the housing are made of sheets of dark material, hung or stretched across the sides of the frame.

The ceiling 26 of the housing is made up of an MDF board which is painted in a dark colour.

The whole housing has a height of 2 metres, a width of 1 metre and a depth of 1 metre, allowing a person of average height and size to easily stand fully within the housing.

The light-cancelling apparatus 20 may further include an image or video recording device (not shown) configured to record an image or video of a person located within the housing.

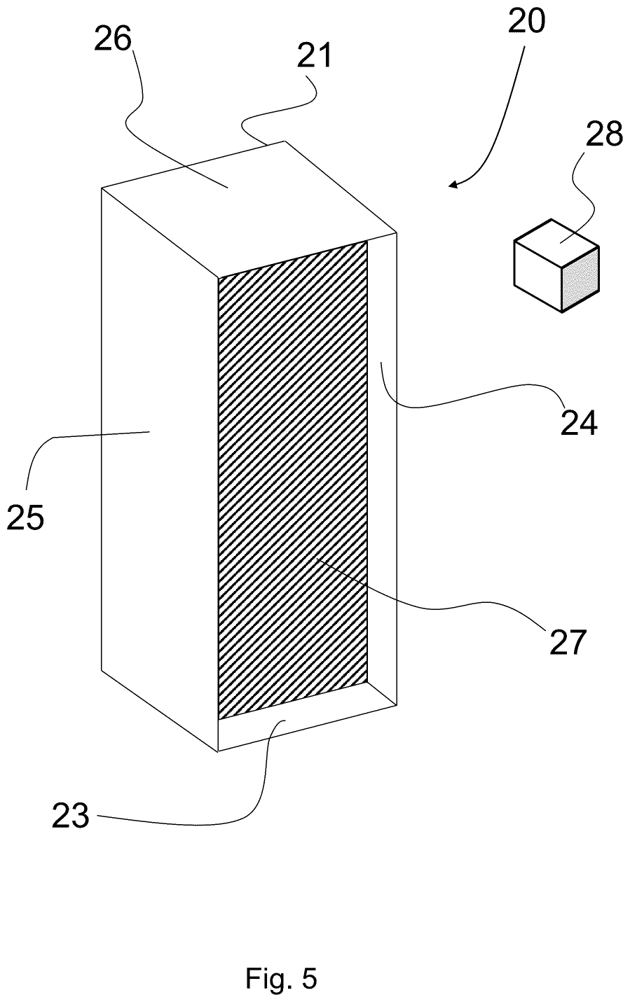

FIG. 5 shows light-cancelling apparatus 20 including a housing 21 having a structure identical to the housing in FIG. 4. However the housing 21 in FIG. 5 now contains a projection display screen 27 which extends across the front opening of the housing 21. A polarised light projector 28 is positioned at the front of the housing 21, configured to project polarised light onto the front surface of the projection display screen 27.

The projection display screen 27 includes four Keder rods around its peripheral edges, which engage with corresponding Keder rails within the housing 21, to secure the projection display screen and to keep its surface flat and taut. In FIG. 5 the projection display screen 27 is shown inset slightly into the housing 21, however it may be located at any suitable depth within the housing (i.e. any suitable distance from the front opening of the housing). In some cases, the projection display screen 27 is located in a plane flush with the front of the housing.

The projection display screen 27 may be a type of screen as described earlier.

During use, polarised light is projected from the projector 28 onto the projection display screen 27. The projected light may be an image or video footage of a person. The image or video footage reflects from the projection display screen, so that it appears to an audience that the person is located within the housing. Any light which passes through the screen and falls onto the floor or internal rear wall of the housing is absorbed by the light-cancelling articles therein, avoiding ghosting effects and enhancing the viewer experience. Light spill onto the internal side walls of the housing is minimised by positioning the projector 28 such that the light is not directed towards the side walls, and as such the side walls do not need to include the light-cancelling articles, but can instead be made of light-absorbent material such as dark fabric. However in some cases, for an optimal viewer experience, all internal surfaces of the housing may include or be covered by the light-cancelling articles described herein.

The light-cancelling apparatus may include two separate housings, a first having the design shown in FIG. 4 and a second having the design shown in FIG. 5, i.e. including a projection display screen. A person is filmed standing within the first housing, and the recorded footage is projected onto the projection display screen within the second housing. In this way, a person who is in reality located within the first housing can appear to remotely appear in the second housing, which may be at a location far from the first housing.

Various modifications of the apparatus setup will be evident to those skilled in the art. For example, for the purposes of the invention, the number of light-cancelling articles employed in the light-cancelling system could vary. Alternatively, the light-cancelling articles could be utilised as wall tiles.

1. A light-cancelling article having a laminate structure comprising a light polarising filter and a substrate.

2. The light-cancelling article according to claim 1, further comprising a light-absorbent layer between the light polarising filter and the substrate.

3. The light-cancelling article according to claim 1 or 2, further comprising connecting means to engage the light-cancelling article with one or more further light-cancelling articles

4. The light-cancelling article according to any one of claims 1-3, wherein the substrate comprises one or more of wood, metal and polymer.

5. The light-cancelling article according to claim 4, wherein the substrate comprises plywood.

6. The light-cancelling article according to any one of claims 1-5, wherein the polarising filter is a linear polariser.

7. The light-cancelling article according to any one of claims 1-6, wherein the polarising filter comprises a polyvinyl alcohol film doped with iodine.

8. The light-cancelling article according to claim 7, wherein the polyvinyl alcohol film is between two tri-acetyl cellulose layers.

9. The light-cancelling article according to any one of claims 1-8, wherein the light-cancelling article further comprises a removable protective film on the surface of the light polarising filter.

10. The light-cancelling article according to claim 9, wherein the protective film comprises polyethylene terephthalate.

11. The light-cancelling article according to any one of claims 1-10, wherein the light-cancelling article is a floor tile or a wall tile.

12. A kit comprising a plurality of light-cancelling articles according to any one of claims 1-11.

13. A light-cancelling system comprising a plurality of light-cancelling articles according to any one of claims 1-11 connected together.

14. A projection apparatus comprising the light-cancelling article according to any one of claims 1-11 or the light-cancelling system according to claim 13, and a projector configured to project polarised light.

15. The projection apparatus according to claim 14, wherein the projection apparatus further comprises a projection display screen.

16. The projection apparatus according to claim 14 or 15, wherein the projector comprises a polarising filter.

17. The use of the projection apparatus according to any one of claims 14-16 to project polarised light onto a surface.

18. The use of the light-cancelling article according to any of claims 1-11 to prevent or ameliorate unwanted light spill during light projection.

19. A light-cancelling apparatus comprising the light-cancelling article according to any one of claims 1-11 or the light-cancelling system according to claim 13, contained within a housing.

20. The light-cancelling apparatus according to claim 19, wherein the housing is of a size which allows a person to be contained within the housing during use.

21. The light-cancelling apparatus according to claim 19 or 20, wherein the light-cancelling apparatus comprises a projection display screen and a projector configured to project polarised light onto the projection display screen.

22. The light-cancelling apparatus according to claim 21, wherein the projection display screen at least partially covers an opening within the housing.

23. The light-cancelling apparatus according to any one of claims 19-22, wherein the housing is an elongate, upright box or booth, comprising an upwardly extending opening on one side which allows a person or object to enter and exit the housing.

24. A method of manufacturing the light-cancelling article according to any one of claims 1-11.
